(19) United States
(12) Patent Application Publication
(10) Pub. No.: US 2026/0038249 A1
(43) Pub. Date: Feb. 5, 2026

(54) Efficient Patch Sampling for Deep Super-Resolution Model Training

(71) Applicant: Bitmovin GmbH, Klagenfurt am Wörthersee (AT)

(72) Inventors: Yiying Wei, Klagenfurt am Wörthersee (AT); Hadi Amirpour, Klagenfurt am Wörthersee (AT); Christian Timmerer, Klagenfurt am Wörthersee (AT)

(73) Assignee: Bitmovin GmbH, Klagenfurt am Wörthersee (AT)

(21) Appl. No.: 19/284,300

(22) Filed: Jul. 29, 2025

Related U.S. Application Data
(60) Provisional application No. 63/676,922, filed on Jul. 30, 2024.

(51) Int. Cl. G06V 10/774; G06T 3/4046; G06T 3/4053; G06V 10/26; G06V 10/62; G06V 10/762; G06V 10/82; G06V 20/40

(52) U.S. Cl. CPC G06V 10/774; G06T 3/4046; G06T 3/4053; G06V 10/26; G06V 10/62; G06V 10/762; G06V 10/82; G06V 20/49

(57) ABSTRACT

Techniques relating to efficient patch sampling for training content-aware models are disclosed. A method for generating a training set of patches for training a content-aware model includes receiving a video input, dividing each frame of the video input into non-overlapping patches, calculating a complexity score for each patch, such as a spatial feature score and a temporal feature score, generating heatmaps of each frame using complexity scores, selecting patches corresponding to a high spatial feature score and a high temporal feature score to generate a training set of informative patches. A content-aware model may be trained using the training set of informative patches and a pre-trained model as a base. Patches may be clustered using a histogram distribution of spatial-temporal features in selecting patches for the training set.

### CROSS-REFERENCE TO RELATED APPLICATIONS

This application claims the benefit of U.S. Provisional Patent Application No. 63/676,922 entitled “Efficient Patch Sampling for Overfitting in Deep Learning Training,” filed Jul. 30, 2024, the contents of which are hereby incorporated by reference in their entirety.

### BACKGROUND OF INVENTION

With the ever-increasing amount of video content, video applications, and the ongoing evolution of video in various dimensions, such as spatial resolution and temporal resolution (frame rate), transmitting high-quality, high0resolution videos presents a significant challenge. In response to these challenges, new video codecs have been introduced, such as Versatile Video Coding (VVC) or AOMedia Video 1 (AV1), which employ more efficient compression techniques to help transmit high-quality video content while reducing bandwidth requirements. However, these video coding methods still face limitations to further improve compression performance, as they rely on hand-crafted techniques and highly engineered modules.

With the development of deep learning, leveraging deep neural networks (DNNs) to enhance video compression has become a new trend in modern video transmission systems. Numerous learning-based video compression methods have been proposed to deliver high-quality video streams to users. Among these approaches, an emerging number of approaches integrate super-resolution (SR) techniques to reduce bandwidth requirements. These methods transmit low-bitrate low-resolution (LR) videos and super-resolve them to high-resolution (HR) videos on the end-user device by applying pre-trained SR models. These SR models are typically trained on a limited dataset and may encounter difficulties adapting to new video content. However, creating a universal DNN model that excels with all Internet videos is impractical. To overcome this limitation, recent advances in neural-enhanced video delivery leverage the over-fitting property of DNNs to achieve quality improvements. These approaches train an SR model for each video and stream the LR video along with the corresponding content-aware SR model to the end-user device. The reinforced expressive power of content-aware SR models significantly improves the quality of resolution-upscaled videos.

Although neural-enhanced video delivery shows promising performance, the huge computational cost of training content-aware SR models limits its practical applications. With a linear increase in the input video resolution, the approach cannot be easily adapted to live streaming with stringent delay requirements. Additionally, it is essential to acknowledge that deploying such models for large-scale video processing and delivery workflows entails significant energy consumption, which poses challenges in terms of sustainability and environmental impact.

To reduce the computational cost of network training, efficient meta-tuning (EMT) has been proposed, using a patch sampling method to select the most informative patches using a patch PSNR heatmap, showing training gains comparable to using all frames. Specifically, it uses a pre-trained SR model to super-resolve all LR patches of one frame, then calculates their PSNR values with the original HR patches to generate the patch PSNR heatmap. The patch PSNR heatmap indeed partially reflects the texture complexity of patches, assisting in the identification of valuable patches for training content-aware models. However, the known patch sampling methods still have a couple of drawbacks:
First, generating patch PSNR heatmaps for all frames is time-consuming. It requires additional computational resources, as it involves the inference of a DNN and calculating PSNR for each patch.
Second, existing methods sample patches only based on the SR quality comparisons without considering temporal redundancy between frames.

Neural-adaptive content-aware internet video delivery (NAS) was one of the first neural-enhanced video delivery frameworks proposed to integrate a per-video SR model. For NAS, a DNN is trained for each LR video content, and both the LR video and its associated DNN are delivered to the client side, which are jointly used to enhance its quality. Live NAS proposed a live video ingest framework that integrates an online training module into the original NAS approach. However, content-aware SR models with large parameters still introduce an overhead to the delivery process. Another existing approach SRVC encodes a video into content streams and time-varying model streams, updating only a fraction of the model parameters over video chunks to better handle the available bandwidth budget. DeepStream is another existing method that utilizes compressed content-aware SR networks to achieve significant bitrate savings while maintaining the same quality for end-user devices with GPU capabilities. Nevertheless, these approaches still demand significant computational resources for training a network.

Therefore, efficient patch sampling for deep super-resolution model training is desirable.

### BRIEF SUMMARY

A system and method are disclosed for efficient patch sampling for deep super-resolution model raining. A method for generating a training set of patches for training a content-aware model may include: receiving a set of video frames; dividing each frame of the set of video frames into non-overlapping patches; for each frame, calculating a set of spatial feature scores and a set of temporal feature scores for the non-overlapping patches; grouping the non-overlapping patches for each frame into N spatial feature clusters based on a spatial feature histogram of the set of spatial feature scores; grouping the non-overlapping patches for each frame into N temporal feature clusters based on a temporal feature histogram of the set of temporal feature scores; for each frame, generating a training set of patches using a highest spatial feature cluster and a highest temporal feature cluster for the frame; and training a content-aware model using the training set of patches. In some examples, the method also may include combining the training set of patches for each frame of the set of video frames into a final training set, the final training set being used in training the content-aware model.

In some examples, the content-aware model comprises a super-resolution (SR) model. In some examples, the content-aware model comprises a deep neural network (DNN). In some examples, the training the content-aware model includes using a pre-trained model as a base. In some examples, a temporal feature score serves as an indicator of redundancy in co-located patches across frames. In some examples, the spatial feature histogram comprises a distribution of the set of spatial feature scores. In some examples, the temporal feature histogram comprises a distribution of the set of temporal feature scores. In some examples, the N spatial feature clusters corresponds to N bins in the spatial feature histogram, and the N temporal feature clusters corresponding to N bins in the temporal feature histogram. In some examples, the training set of patches comprises an empty set. In some examples, the set of spatial feature scores and the set of temporal feature scores comprise DCT-based complexity scores.

An alternative method for generating a training set of patches for training a content-aware model may include: receiving a video input comprising a set of frames; dividing each frame of the set of frames into a grid of non-overlapping patches; calculating a DCT-based complexity score for each patch in the grid, the DCT-based complexity score comprising a spatial feature score and a temporal feature score; generating a spatial features heatmap and a temporal features heatmap using the spatial feature score and the temporal feature score; selecting a plurality of patches of the video input, each of the plurality of patches corresponding to a patch in the grid having a high spatial feature score and a high temporal feature score; and outputting a set of informative patches comprising the plurality of patches. In some examples, the method also includes training a content-aware model using the set of informative patches.

In some examples, the content-aware model comprises a super-resolution (SR) model. In some examples, the content-aware model comprises a deep neural network (DNN). In some examples, the set of informative patches comprise a training set of patches. In some examples, the method also includes clustering the non-overlapping patches using a histogram distribution of spatial-temporal features, the spatial-temporal features comprising a list of spatial feature scores and temporal feature scores. In some examples, the spatial feature scores and the temporal feature scores are clustered into N clusters, the N clusters based on a number of bins in the histogram distribution.

A system for generating a training set of patches for training a content-aware model may include: a memory comprising non-transitory computer-readable storage medium configured to store video data; one or more processors configured to execute instructions stored on the non-transitory computer-readable storage medium to: receive a set of video frames; divide each frame of the set of video frames into non-overlapping patches; for each frame, calculate a set of spatial feature scores and a set of temporal feature scores for the non-overlapping patches; group the non-overlapping patches for each frame into N spatial feature clusters based on a spatial feature histogram of the set of spatial feature scores; group the non-overlapping patches for each frame into N temporal feature clusters based on a temporal feature histogram of the set of temporal feature scores; for each frame, generate a training set of patches using a highest spatial feature cluster and a highest temporal feature cluster for the frame; and train a content-aware model using the training set of patches.

A system for generating a training set of patches for training a content-aware model may include: a memory comprising non-transitory computer-readable storage medium configured to store video data; one or more processors configured to execute instructions stored on the non-transitory computer-readable storage medium to: receive a video input comprising a set of frames; divide each frame of the set of frames into a grid of non-overlapping patches; calculate a DCT-based complexity score for each patch in the grid, the DCT-based complexity score comprising a spatial feature score and a temporal feature score; generate a spatial features heatmap and a temporal features heatmap using the spatial feature score and the temporal feature score; select a plurality of patches of the video input, each of the plurality of patches corresponding to a patch in the grid having a high spatial feature score and a high temporal feature score; and output a set of informative patches comprising the plurality of patches.

### BRIEF DESCRIPTION OF THE DRAWINGS

Various non-limiting and non-exhaustive aspects and features of the present disclosure are described hereinbelow with references to the drawings, wherein:

FIG. 1A is a simplified block diagram illustrating a prior art patch sampling using a PSNR heatmap.

FIG. 1B is a simplified block diagram illustrating an exemplary workflow for efficient patch sampling using a DCT-based complexity score, in accordance with one or more embodiments.

FIG. 2 is a simplified block diagram illustrating an exemplary workflow for efficient patch sampling for deep super-resolution (SR) model training, in accordance with one or more embodiments.

FIG. 3 is a series of charts showing exemplary heatmaps of spatial feature and temporal feature scores, in accordance with one or more embodiments.

FIG. 4 is a simplified block diagram illustrating an exemplary data flow for an efficient patch sampling algorithm for SR model training, in accordance with one or more embodiments.

FIG. 5A is a flow diagram illustrating an exemplary method for generating a set of informative patches for efficient patch sampling for training a content-aware SR model, in accordance with one or more embodiments.

FIG. 5B is a flow diagram illustrating an exemplary method for generating a training set of patches for training a content-aware SR model, in accordance with one or more embodiments.

FIG. 6A is a simplified block diagram of an exemplary computing system configured to implement the workflows shown in FIGS. 1A-2 and to perform steps of the method illustrated in FIGS. 5A-5B, in accordance with one or more embodiments.

FIG. 6B is a simplified block diagram of an exemplary distributed computing system implemented by a plurality of the computing devices, in accordance with one or more embodiments.

Like reference numbers and designations in the various drawings indicate like elements. Skilled artisans will appreciate that elements in the Figures are illustrated for simplicity and clarity, and have not necessarily been drawn to scale, for example, with the dimensions of some of the elements in the figures exaggerated relative to other elements to help to improve understanding of various embodiments. Common, well-understood elements that are useful or necessary in a commercially feasible embodiment are often not depicted in order to facilitate a less obstructed view of these various embodiments.

### DETAILED DESCRIPTION

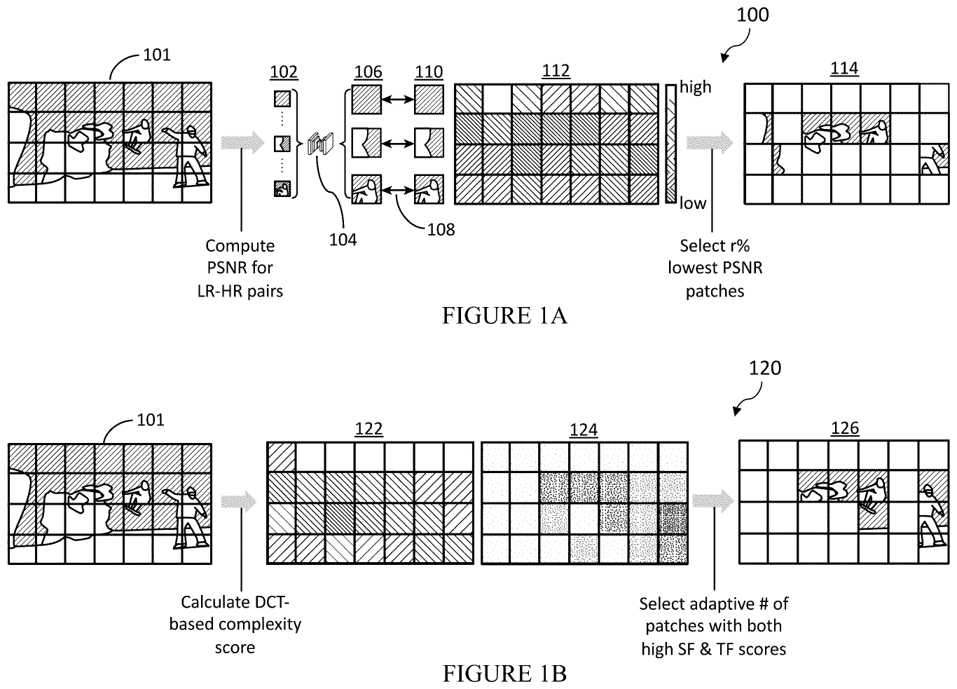

The invention is directed to efficient patch sampling for video overfitting in deep super-resolution model training. This invention comprises efficient patch sampling techniques for high-quality and efficient video super-resolution. As shown in FIG. 1, efficient patch sampling techniques leverage spatial-temporal information to quickly select the most informative patches from video frames without the need to super-resolve frames and calculate the quality.

Online training attempts to avoid the need for excessive computational resources for inference of a DNN and calculating PSNR for each patch. When temporal complexity is low—indicating that a patch is similar to its co-located patch in the previous frame—it can be excluded from the training set due to the redundancy, thus reducing unnecessary computation load. An efficient patch sampling method, as described herein, can mitigate the need for significant computational resources for training a network for an SR model.

In some examples, an efficient patch sampling method for high quality and efficient video super resolution may leverage spatial-temporal information to quickly select the most informative patches from video frames without the need to super-resolve frames and calculate the quality. The methods described herein introduce two DCT-based features to directly evaluate spatial and temporal complexity of patches in low resolution (LR) video frames. Compared to PSNR heatmaps that rely on DNN inference and are calculated on patches after super resolution by comparing them to corresponding high resolution patches, DCT is a low-complexity computation on LR patches that enables faster execution on both CPU and GPU, significantly speeding up informative patch scoring. An efficient patch sampling method may sample patches by considering both temporal and spatial dimensions as the training set for the content-aware SR model. Relatively static patches across frames are excluded from repeated training, thereby reducing temporal redundancies. In summary, two low-complexity DCT-based informative features are introduced herein to measure the spatial-temporal complexity of each LR-HR patch pair, and a novel patch sampling algorithm for content-aware video SR training is described herein, which utilizes histogram distribution of patch features for clustering to select the patches with the highest spatial-temporal information. This approach is fast and effective in guiding the selection of the most informative patches, making the content-aware training gain appear as large and quickly as possible. In some examples, complex patches may be sampled using simple, yet efficient, DCT-based features that account for both spatial and temporal information.

FIG. 1A is a simplified block diagram illustrating a prior art patch sampling using a PSNR heatmap. In the prior art patch sampling method shown in diagram 100, PSNR for each LR-HR patch pair is computed for a video input 101 to extract the informative patches. As shown, LR patches 102 may be upscaled by model 104 to SR patches 106 and HR patches 108. Using traditional patch sampling methods, patch PSNR heatmap 112 indicates low and high complexity patches, and r % lowest PSNR patches are selected for a resulting set of informative patches 114.

FIG. 1B is a simplified block diagram illustrating an exemplary workflow for efficient patch sampling using a DCT-based complexity score, in accordance with one or more embodiments. In contrast, diagram 120 shows a calculation of DCT-based complexity scores to derive a heatmap of spatial features (SF) 122 and heatmap of temporal features (TF) 124 from the same video input 101. An SF score may indicate a complexity of the texture information within a patch, and a TF score may indicate movement and change between frames to help reduce temporal redundancies for patch sampling. An adaptive number of patches with both high SF and TF scores may be selected to generate a resulting set of informative patches 126.

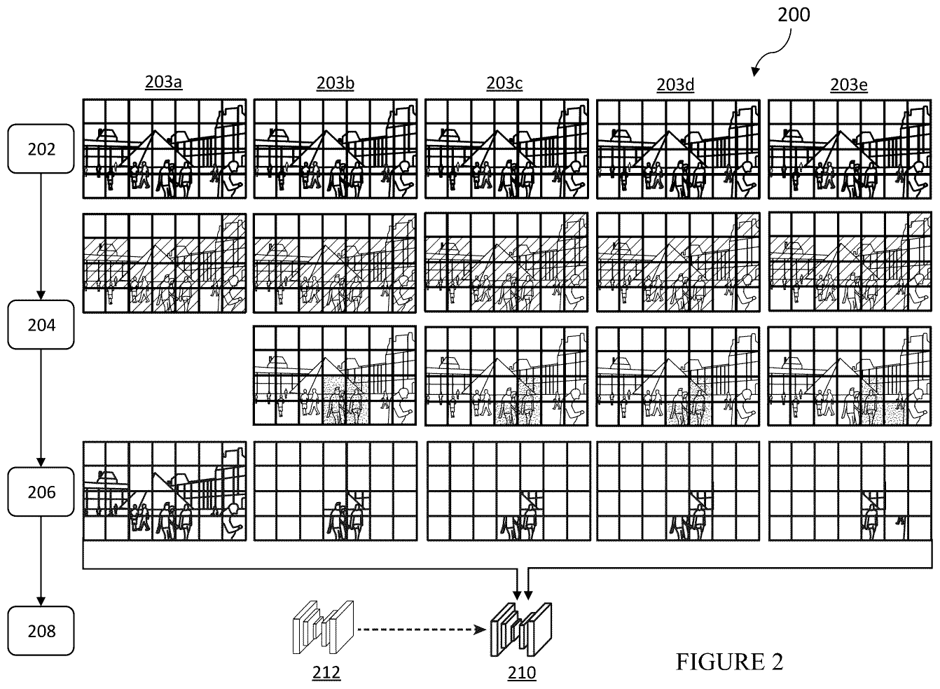

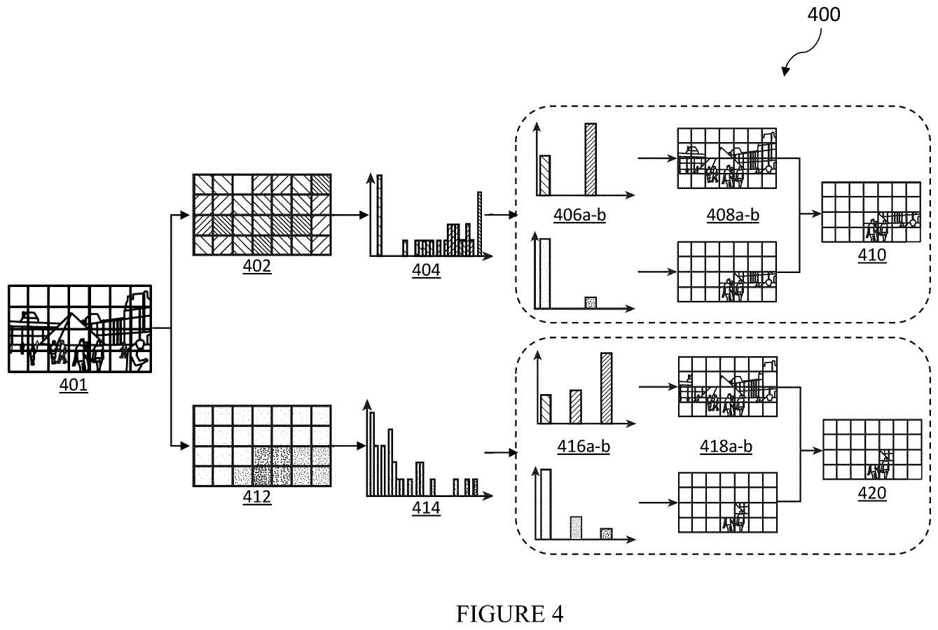

FIG. 2 is a simplified block diagram illustrating an exemplary overview workflow for efficient patch sampling for deep super-resolution (SR) model training, in accordance with one or more embodiments. In diagram 200, an LR video may first be split into frames 203a-203e at step 202, with each frame 203a-203e being divided into a grid of non-overlapping patches. SF and TF scores may be calculated at 204 for each of frames 203a-203e to evaluate the texture complexity of each patch. In some examples, the SF and TF scores may be used to determine an informative complexity of a patch. The patches may be grouped into N clusters according to a histogram distribution of proposed features (e.g., as shown in FIG. 4). Patches of the cluster with the highest spatial-temporal information may be selected to train a content-aware SR model (e.g., a neural network, a DNN). At 206, sample training patches having both high SF and high TF scores have been identified (e.g., selected), and said sample training patches may be provided at 208 to train a content-aware model 210 (e.g., an SR model, a DNN). In some examples, a pre-trained model 212 may be used as a basis for training content-aware model 210 with the cluster of highest spatial-temporal informative patches, as selected at 206. More informative patches (e.g., highest spatial-temporal informative patches) may provide higher training gains than others. Given that not all parts of a video are equally important for training, patch sampling aims to quickly select challenging patches and discard uninformative or redundant patches. In other examples, a workflow for efficient patch sampling using a DCT-based complexity score may comprise more or fewer steps, as described herein. For example, histogram distributions may be generated for clustering of SF scores and TF scores, a described herein.

As described herein, the two informative features SF and TF may be used to efficiently sample patches that achieve these patch sampling goals. The complexity of a patch is related to its frequency components, where a higher proportion of high frequencies typically indicates a more complex texture and content. Thus, the informative features of a patch may be assessed based on its frequency components. A DCT-based energy function may be used to map the texture of a patch from a multiple-dimensional frequency space into a one-dimensional energy space. This energy function reflects the spatial complexity of a patch, which may be denoted as SF. The SF of a patch may be defined as:

$$SF = {\sum }_{i = 0}^{w - 1} {\sum }_{j = 0}^{h - 1} {e}^{[ {( \frac{ij}{wh} )}^{2} - 1 ]} \vert DCT ( i , j ) \vert \qquad ( 1 )$$

where w and h are the width and height of the patch, and DCT(i, j) is the (i, j)^{th} DCT component when i+j>0, and 0 otherwise. The function SF assigns exponentially higher costs to higher DCT frequencies since we expect the highest frequencies to be caused by a mixture of objects. TF defines the complexity of the temporal variation between video frames and may be computed as a difference of the DCT component of each patch of the current frame compared to its previous frame. Formally, the total T frames of a given LR video may be denoted as I₁, I₂, . . . , I_{T}. For a patch of frame Iₜ (1<t≤T), the TF may be defined as follows:

$${TF}_{t} = {\sum }_{i - 0}^{w - 1} {\sum }_{j = 0}^{h - 1} {e}^{[ {( \frac{ij}{wh} )}^{2} - 1 ]} \vert {DCT ( i , j )}_{t} - {DCT ( i , j )}_{t - 1} \vert \qquad ( 2 )$$

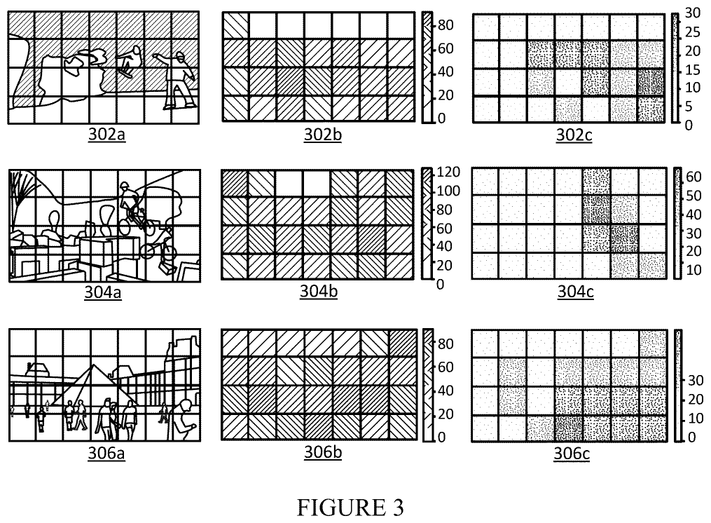

FIG. 3 is a series of charts showing exemplary heatmaps of spatial feature and temporal feature scores, in accordance with one or more embodiments. In some examples, frames 302a, 304a, and 306a (e.g., w=64, h=64) may be from an exemplary dataset (e.g., video frames from a video input). Frames 302a, 304a, and 306a may be divided (e.g., sliced) into a plurality of patches. SF heatmap 302b and TF heatmap 302c correspond to frame 302a. SF heatmap 304b and TF heatmap 304c correspond to frame 304a. SF heatmap 306b and TF heatmap 306c correspond to frame 306a. A high SF score represents a complex texture and rich patch information. Consequently, a high TF score indicates that the patch in frame Iₜ has obvious changes compared to Iₜ₋₁. Therefore, a TF score may serve as an indicator of redundancy in co-located patches across frames.

Wherein prior art patch sampling relies on setting fixed thresholds for sampling by selecting a top r % of patches according to their information complexity, the efficient patch sampling methods described herein (and shown in FIGS. 1B-4) use a histogram distribution of spatial-temporal features for clustering to conduct patch sampling. An exemplary patch sampling algorithm is shown in Algorithm 1, wherein patches with the highest spatial-temporal information are selected, and uninformative or redundant patches are discarded. In Algorithm 1, LR-HR patch pairs P are sampled to train a content-aware SR model of a T-frame video sequence (e.g., a video sequence comprising T frames).

Algorithm 1 Patch Sampling Strategy

Input: Video frame sequences {I₁, I₂, ..., Iₜ, ..., I_{T}}, Number of clusters N
Output: Sampled training patches P

| | |
|---|---|
| 1: | for t = 1 → T do |
| 2: | m=sliceFrame(Iₜ) // Slice frame Iₜ to m patches |
| 3: | SF=calcSF(m) // Calculate SF scores for m patches according to |
| | Equation (1) |
| 4: | C_{SF}=cluster(m,N,SF) // Group m into N clusters based on SF, |
| | i.e., the N bins of SF histogram |
| 5: | C_{SF}=rank(C_{SF}) // Rank SF clusters from low to high |
| | {C_{SF}_{₁}, ..., C_{SF}_{_{N}}} |
| 6: | if t > 1 then |
| 7: | TF=calcTF(m) // Calculate TF scores for m patches according |
| | to Equation (2) |
| 8: | C_{TF}=cluster(m,N,TF) // Group m into N clusters based on |
| | TF, i.e., the N bins of TF histogram |
| 9: | C_{TF}=rank(C_{TF}) // Rank TF clusters from low to high |
| | {C_{TF}_{₁}, ..., C_{TF}_{_{N}}} |
| 10: | end if |
| 11: | if t == 1 then |
| 12: | P₁ = C_{SF}_{_{N}} |
| 13: | else |
| 14: | Pₜ = C_{SF}_{_{N}} ∩ C_{TF}_{_{N}} |
| 15: | end if |
| 16: | end for |
| 17: | return P = {P₁, P₂, ..., Pₜ, ..., P_{T}} |

In an example, the resolution of a given LR video is W×H, and the LR patch size is w×h. The corresponding HR patch width and height are w×k and h×k, where k is the scaling factor. As shown in FIG. 3, frames 302a, 304a, and 306a may be sliced into patches of C columns and L rows, in which case, the total number of patches for each frame is C×L. Note that the

$$C = ⌊ \frac{W}{w} ⌋$$

and the

$$L = ⌊ \frac{H}{h} ⌋$$

are integer numbers, ignoring the possible remaining borders of the frame.

For a first frame I₁, the SF scores for all patches may be derived according to Equation (1) above, and then these SF scores (i.e., values) may be listed as a monotonically increasing histogram. Based on the distribution of this histogram, the patches may be partitioned into N clusters, corresponding to the N bins of the histogram. Therefore, the distribution of patch numbers among different clusters is based on information density. The training set P₁ may be defined as the patches from the highest SF cluster C_{SF}_{_{N}}, which are expected to possess the most informative and challenging texture characteristics.

For all subsequent frames Iₜ (2≤t≤T), informative patches are sampled considering both spatial and temporal complexity. The SF and TF scores for all patches in Iₜ are calculated in parallel using Equation (1) and Equation (2), respectively. These SF and TF scores are individually listed as two histograms, and the corresponding patches are partitioned into N-numbered TF clusters (C_{SF}, C_{TF}). The patches in the highest SF and TF clusters are provided as training set Pₜ. In some examples, Pₜ might be an empty set, meaning no training patches are meeting the requirements for a given frame, thereby reducing the total number of patches. All selected patches from each frame may be combined as the final training set P. This approach saves time and computational resources and maintains model performance when no new information is available for fine-tuning.

FIG. 4 is a simplified block diagram illustrating an exemplary data flow for an efficient patch sampling algorithm for SR model training, in accordance with one or more embodiments. In diagram 400, a frame 401 of a video input undergoes efficient patch sampling as described herein. In the process, SF heatmap 402 and TF heatmap 412 are generated, and then used to generate SF histogram 404 and TF histogram 414, respectively. In some examples, a number of sampled patches may be adjusted by grouping the SF and TF scores into N clusters, which may be based on a number of bins in the histogram. For example, SF and TF histograms 406a-b and SF and TF histograms 416a-b show examples where N={2, 3}, respectively. Specifically, SF and TF histograms 406a-b are grouped into 2 clusters (i.e., N=2), and SF and TF histograms 416a-b are grouped into 3 clusters (i.e., N=3). SF and TF histograms 406a-b give rise to resulting set of sampled patches (Pₜ) 410. SF and TF histograms 416a-b give rise to resulting set of sampled patches (Pₜ) 420.

A key advantage of the methods described herein includes potential integration with an encoding process, utilizing DCT calculations in codec to accelerate patch selection. Clustering achieves higher performance than sampling with a fixed number of patches, and better accounts for content dependency by adapting the number of selected patches based on video complexity. More patches are therefore chosen for complex videos, while fewer are selected for simpler ones. By dynamically adjusting the number of clusters, a reduction in the number of training patches is achieved (e.g., from 73% to 95% or more) while maintaining quality. For an SR model with very small size of parameters (e.g., FSRCNN, ESPCN, etc.), even a limited patch selection can yield improved results.

Another advantage is that in selecting more informative patches, the content-aware SR model may learn from higher-quality data. The methods described herein can still achieve promising training improvement at high quantization parameter(s) (QP).

To reduce computational costs while maintaining overfitting quality, the most informative patches from video frames may be sampled to accelerate training. Frames are partitioned into non-overlapping patches and texture and motion complexity are assessed using two DCT-based metrics: SF (spatial feature) and TF (temporal feature). Subsequently for each frame, SF and TF values may be grouped into N clusters and patches selected belonging to the N^{th} cluster in both SF and TF. Improved SR quality performance may be achieved with significant reduction in training input.

In some examples, bicubic downsampling may be applied to downscale an original version of a video input to a desired HR video resolution. For LR video, two scaling factors (e.g., x2 and x4) may be used and all LR videos compressed with four quantization parameters (QPs) values (e.g., using an x265 encoder). PSNR and VMAF may be adopted as evaluation metrics to measure SR performance.

### Example Methods

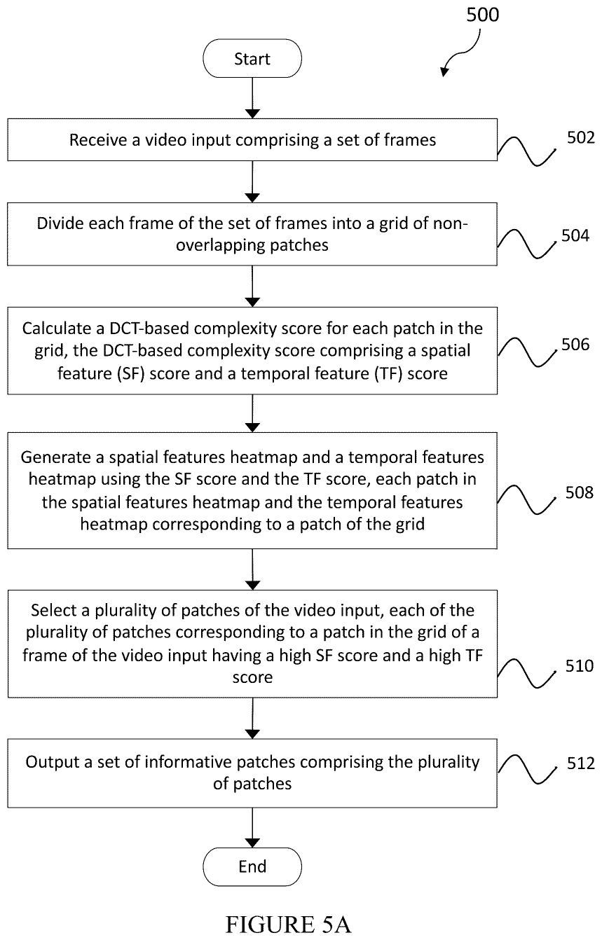

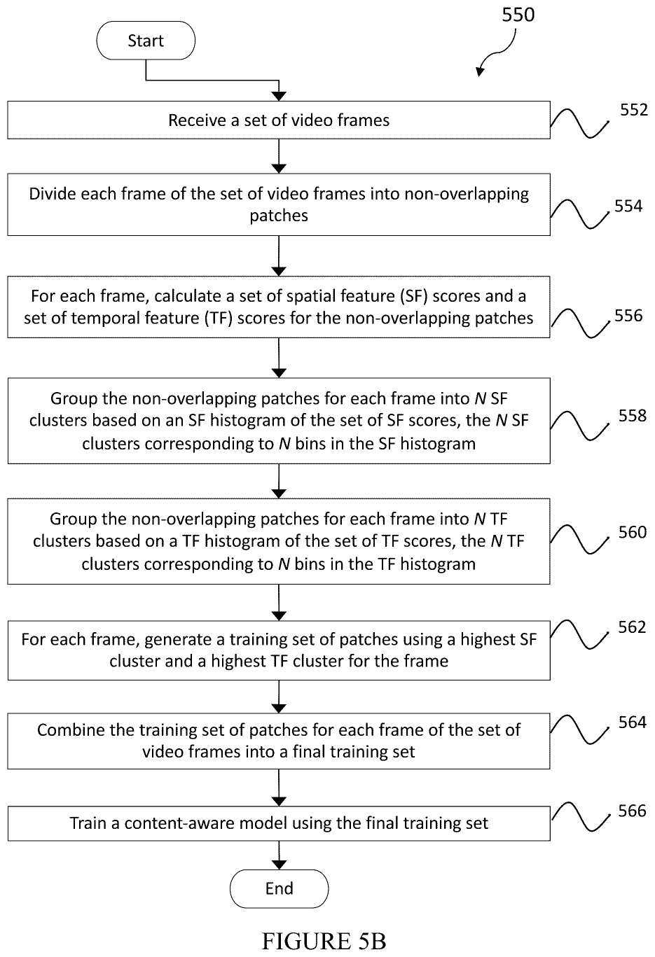

FIG. 5A is a flow diagram illustrating an exemplary method for generating a set of informative patches for efficient patch sampling for training a content-aware SR model, in accordance with one or more embodiments. In method 500, a video input is received by an efficient patch sampling system at step 502, the video input comprising a set of frames. Each frame of the set of frames may be divided into a grid of non-overlapping patches at step 504. A DCT-based complexity score for each patch in the grid may be calculated at step 506, the DCT-based complexity score comprising a spatial feature (SF) score and a temporal feature (TF) score, as described herein. The SF and TF scores may be computed using the equations provided herein. A spatial features heatmap and a temporal features heatmap may be generated using the SF and TF scores at step 508, each patch in the spatial features heatmap and the temporal features heatmap corresponding to a patch of the grid. A plurality of patches of the video input may be selected at step 510, each of the plurality of patches corresponding to a patch in the grid having a high SF score and a high TF score. In some examples, the plurality of patches may be identified by clustering patches using a histogram of the SF and TF scores. A set of informative patches comprising the plurality of patches may be output at step 512. In some examples, this output may be used to train a content-aware model (e.g., SR model, DNN) for video streaming (e.g., live streaming). In some examples, the content-aware model may be trained using a pre-trained model as a basis.

FIG. 5B is a flow diagram illustrating an exemplary method for generating a training set of patches for training a content-aware model, in accordance with one or more embodiments. Method 550 may begin with receiving a set of video frames at step 552, for example, frames from a video input, as described herein. Each frame of the set of video frames may be divided into non-overlapping patches at step 554. For each frame, a set of spatial feature (SF) scores and a set of temporal feature (TF) scores may be calculated for the non-overlapping patches at step 556. The non-overlapping patches for each frame may be grouped into N(-numbered) SF clusters based on an SF histogram of the set of SF scores at step 558, the N SF clusters corresponding to N bins in the SF histogram. The non-overlapping patches for each frame also may be grouped into N(-numbered) TF clusters based on an TF histogram of the set of TF scores at step 560, the N TF clusters corresponding to N bins in the TF histogram. In some examples, the SF histogram and TF histogram may be generated in parallel and/or separately. In some examples, the N SF clusters and the N TF clusters also may be generated in parallel and/or separately. For each frame, a training set of patches using a highest SF cluster and a highest TF cluster for the frame may be generated at step 562. In some examples, the training set of patches for a given frame may be an empty set, as described herein. The training set of patches for each frame of the set of video frames may be combined into a final training set at step 564. A content-aware model (e.g., an SR model, a DNN) may be trained using the final training set at step 566.

### Example Computing Systems

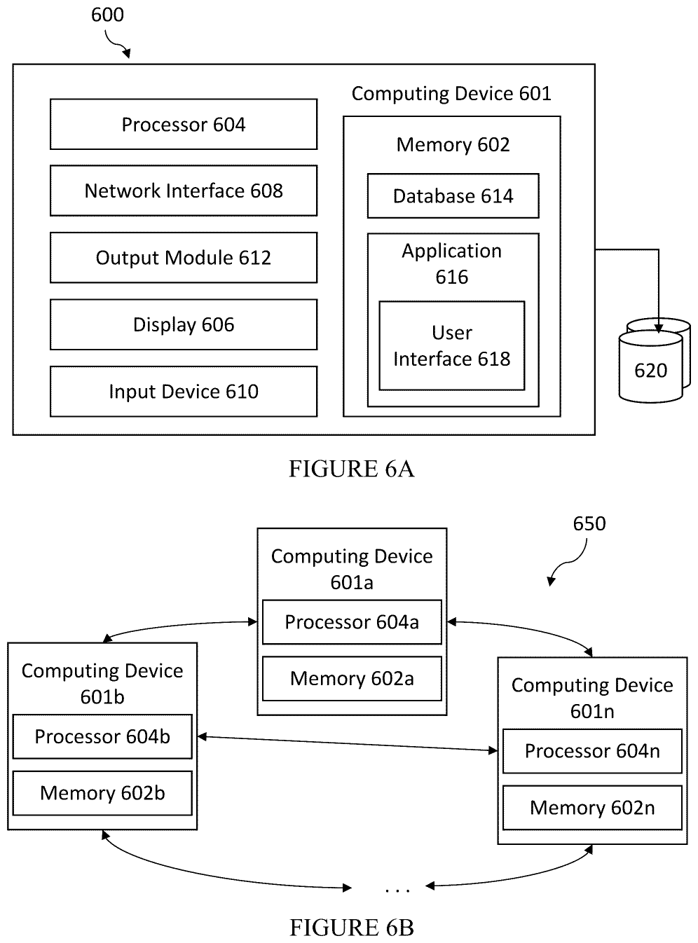

FIG. 6A is a simplified block diagram of an exemplary computing system configured to implement the workflows shown in FIGS. 1A-2 and to perform steps of the method illustrated in FIGS. 5A-5B, in accordance with one or more embodiments. In one embodiment, computing system 600 may include computing device 601 and storage system 620. Storage system 620 may comprise a plurality of repositories and/or other forms of data storage, and it also may be in communication with computing device 601. In another embodiment, storage system 620, which may comprise a plurality of repositories, may be housed in one or more of computing device 601. In some examples, storage system 620 may store video data (e.g., frames, informative features, patches, histograms, etc.), bitrate ladders, instructions, programs, and other various types of information as described herein. This information may be retrieved or otherwise accessed by one or more computing devices, such as computing device 601, in order to perform some or all of the features described herein. Storage system 620 may comprise any type of computer storage, such as a hard-drive, memory card, ROM, RAM, DVD, CD-ROM, write-capable, and read-only memories. In addition, storage system 620 may include a distributed storage system where data is stored on a plurality of different storage devices, which may be physically located at the same or different geographic locations (e.g., in a distributed computing system such as system 650 in FIG. 6B). Storage system 620 may be networked to computing device 601 directly using wired connections and/or wireless connections. Such network may include various configurations and protocols, including short range communication protocols such as Bluetooth™, Bluetooth™ LE, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

Computing device 601 also may include a memory 602. Memory 602 may comprise a storage system configured to store a database 614 and an application 616. Application 616 may include instructions which, when executed by a processor 604, cause computing device 601 to perform various steps and/or functions, as described herein. Application 616 further includes instructions for generating a user interface 618 (e.g., graphical user interface (GUI)). Database 614 may store various algorithms and/or data, including neural networks (e.g., SR models, content-aware models, other DNNs, etc.) and data regarding bitrates, framerates, encoding, video resolution, complexity and other informative features, and/or patches, thresholds and parameters, among other types of data. Memory 602 may include any non-transitory computer-readable storage medium for storing data and/or software that is executable by processor 604, and/or any other medium which may be used to store information that may be accessed by processor 604 to control the operation of computing device 601.

Computing device 601 may further include a display 606, a network interface 608, an input device 610, and/or an output module 612. Display 606 may be any display device by means of which computing device 601 may output and/or display data. Network interface 608 may be configured to connect to a network using any of the wired and wireless short range communication protocols described above, as well as a cellular data network, a satellite network, free space optical network and/or the Internet. Input device 610 may be a mouse, keyboard, touch screen, voice interface, and/or any or other hand-held controller or device or interface by means of which a user may interact with computing device 601. Output module 612 may be a bus, port, and/or other interface by means of which computing device 601 may connect to and/or output data to other devices and/or peripherals.

In one embodiment, computing device 601 is a data center or other control facility (e.g., configured to run a distributed computing system as described herein), and may communicate with a media playback device. As described herein, system 600, and particularly computing device 601, may be used for encoding video, downscaling video, upscaling video, optimizing and constructing a bitrate ladder, computing complexity and informative features, selecting training sets of patches, and otherwise implementing steps in efficient patch sampling for training SR models and other DNNs, as described herein. Various configurations of system 600 are envisioned, and various steps and/or functions of the processes described herein may be shared among the various devices of system 800 or may be assigned to specific devices.

FIG. 6B is a simplified block diagram of an exemplary distributed computing system implemented by a plurality of the computing devices, in accordance with one or more embodiments. System 650 may comprise two or more computing devices 601a-n. In some examples, each of 601a-n may comprise one or more of processors 604a-n, respectively, and one or more of memory 602a-n, respectively. Processors 604a-n may function similarly to processor 604 in FIG. 6A, as described above. Memory 602a-n may function similarly to memory 602 in FIG. 6A, as described above.

While specific examples have been provided above, it is understood that the present invention can be applied with a wide variety of inputs, thresholds, ranges, and other factors, depending on the application. For example, the time frames, rates, ratios, and ranges provided above are illustrative, but one of ordinary skill in the art would understand that these time frames and ranges may be varied or even be dynamic and variable, depending on the implementation.

As those skilled in the art will understand a number of variations may be made in the disclosed embodiments, all without departing from the scope of the invention, which is defined solely by the appended claims. It should be noted that although the features and elements are described in particular combinations, each feature or element can be used alone without other features and elements or in various combinations with or without other features and elements. The methods or flow charts provided may be implemented in a computer program, software, or firmware tangibly embodied in a computer-readable storage medium for execution by a general-purpose computer or processor.

Examples of computer-readable storage mediums include a read only memory (ROM), random-access memory (RAM), a register, cache memory, semiconductor memory devices, magnetic media such as internal hard disks and removable disks, magneto-optical media, and optical media such as CD-ROM disks.

Suitable processors include, by way of example, a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, or any combination of thereof.

What is claimed is:

1. A method for generating a training set of patches for training a content-aware model comprising:
receiving a set of video frames;
dividing each frame of the set of video frames into non-overlapping patches;
for each frame, calculating a set of spatial feature scores and a set of temporal feature scores for the non-overlapping patches;
grouping the non-overlapping patches for each frame into N spatial feature clusters based on a spatial feature histogram of the set of spatial feature scores;
grouping the non-overlapping patches for each frame into N temporal feature clusters based on a temporal feature histogram of the set of temporal feature scores;
for each frame, generating a training set of patches using a highest spatial feature cluster and a highest temporal feature cluster for the frame; and
training a content-aware model using the training set of patches.

2. The method of claim 1, further comprising combining the training set of patches for each frame of the set of video frames into a final training set, the final training set being used in training the content-aware model.

3. The method of claim 1, wherein the content-aware model comprises a super-resolution (SR) model.

4. The method of claim 1, wherein the content-aware model comprises a deep neural network (DNN).

5. The method of claim 1, wherein the training the content-aware model includes using a pre-trained model as a base.

6. The method of claim 1, wherein a temporal feature score serves as an indicator of redundancy in co-located patches across frames.

7. The method of claim 1, wherein the spatial feature histogram comprises a distribution of the set of spatial feature scores.

8. The method of claim 1, wherein the temporal feature histogram comprises a distribution of the set of temporal feature scores.

9. The method of claim 1, wherein the N spatial feature clusters corresponds to N bins in the spatial feature histogram, and the N temporal feature clusters corresponding to N bins in the temporal feature histogram.

10. The method of claim 1, wherein the training set of patches comprises an empty set.

11. The method of claim 1, wherein the set of spatial feature scores and the set of temporal feature scores comprise DCT-based complexity scores.

12. A method for generating a training set of patches for training a content-aware model comprising:
receiving a video input comprising a set of frames;
dividing each frame of the set of frames into a grid of non-overlapping patches;
calculating a DCT-based complexity score for each patch in the grid, the DCT-based complexity score comprising a spatial feature score and a temporal feature score;
generating a spatial features heatmap and a temporal features heatmap using the spatial feature score and the temporal feature score;
selecting a plurality of patches of the video input, each of the plurality of patches corresponding to a patch in the grid having a high spatial feature score and a high temporal feature score; and
outputting a set of informative patches comprising the plurality of patches.

13. The method of claim 12, further comprising training a content-aware model using the set of informative patches.

14. The method of claim 13, wherein the content-aware model comprises a super-resolution (SR) model.

15. The method of claim 13, wherein the content-aware model comprises a deep neural network (DNN).

16. The method of claim 12, wherein the set of informative patches comprise a training set of patches.

17. The method of claim 12, further comprising clustering the non-overlapping patches using a histogram distribution of spatial-temporal features, the spatial-temporal features comprising a list of spatial feature scores and temporal feature scores.

18. The method of claim 17, wherein the spatial feature scores and the temporal feature scores are clustered into N clusters, the N clusters based on a number of bins in the histogram distribution.

19. A system for generating a training set of patches for training a content-aware model comprising:
a memory comprising non-transitory computer-readable storage medium configured to store video data;
one or more processors configured to execute instructions stored on the non-transitory computer-readable storage medium to:
receive a set of video frames;
divide each frame of the set of video frames into non-overlapping patches;
for each frame, calculate a set of spatial feature scores and a set of temporal feature scores for the non-overlapping patches;
group the non-overlapping patches for each frame into N spatial feature clusters based on a spatial feature histogram of the set of spatial feature scores;
group the non-overlapping patches for each frame into N temporal feature clusters based on a temporal feature histogram of the set of temporal feature scores;
for each frame, generate a training set of patches using a highest spatial feature cluster and a highest temporal feature cluster for the frame; and
train a content-aware model using the training set of patches.

20. A system for generating a training set of patches for training a content-aware model comprising:
a memory comprising non-transitory computer-readable storage medium configured to store video data;
one or more processors configured to execute instructions stored on the non-transitory computer-readable storage medium to:
receive a video input comprising a set of frames;
divide each frame of the set of frames into a grid of non-overlapping patches;
calculate a DCT-based complexity score for each patch in the grid, the DCT-based complexity score comprising a spatial feature score and a temporal feature score;
generate a spatial features heatmap and a temporal features heatmap using the spatial feature score and the temporal feature score;
select a plurality of patches of the video input, each of the plurality of patches corresponding to a patch in the grid having a high spatial feature score and a high temporal feature score; and
output a set of informative patches comprising the plurality of patches.
